SEQUENCE LISTING (14 sequences)

SEQ ID NO: 1 - DNA, 20 bp, Persea americana
cacaggacgcatcaccagaa

SEQ ID NO: 2 - DNA, 19 bp, Persea americana
tgcgggaaacatcatccaa

SEQ ID NO: 3 - DNA, 18 bp, Persea americana
aggcgatggcgtcaactc

SEQ ID NO: 4 - DNA, 20 bp, Persea americana
cctctcgccgctaattacca

SEQ ID NO: 5 - DNA, 20 bp, Persea americana
aaggctcggtggtgttgatg

SEQ ID NO: 6 - DNA, 19 bp, Persea americana
tcgccatgttctgcactga

SEQ ID NO: 7 - DNA, 20 bp, Persea americana
agttgaggcgggtctgattt

SEQ ID NO: 8 - DNA, 21 bp, Persea americana
tcccttcttccctccagacat

SEQ ID NO: 9 - DNA, 18 bp, Persea americana
gcccacacggacatgagt

SEQ ID NO: 10 - DNA, 21 bp, Persea americana
ggccaccagttcccatctttc

SEQ ID NO: 11 - DNA, 20 bp, Persea americana
ggcgggttcggaagaaacac

SEQ ID NO: 12 - DNA, 22 bp, Persea americana
gccctcccatcatactggattc

SEQ ID NO: 13 - DNA, 24 bp, Persea americana
agctcgcttatgtggctcttgact

SEQ ID NO: 14 - DNA, 24 bp, Persea americana
tctcatggattccagcagcttcca

(19) United States
(12) Patent Application Publication
(10) Pub. No.: US 2023/0287234 A1
(43) Pub. Date: Sep. 14, 2023

(54) EDIBLE COATINGS FOR MAINTAINING FRUIT QUALITY

(71) Applicant: The State of Israel, Ministry of Agriculture & Rural Development, Agricultural Research Organization, Rishon Lezion (IL)

(72) Inventors: Noam ALKAN, Kidron (IL); Elena POVERENOV, Nes Ziona (IL); Lilach SAIDI, Gedera (IL); Dalia MAURER, Holon (IL); Oleg FEYGENBERG, Holon (IL)

(21) Appl. No.: 18/019,808

(22) PCT Filed: Aug. 5, 2021
(86) PCT No.: PCT/IL2021/050956

§ 371 Date: Feb. 5, 2023

Related U.S. Application Data
(60) Provisional application No. 63/061,346, filed on Aug. 5, 2020.

(51) Int. Cl. C09D 105/08; C09D 101/28; C09D 105/04; C08K 5/17; C08K 5/09

(52) U.S. Cl. CPC C09D 105/08; C09D 101/286; C09D 105/04; C08K 5/175; C08K 5/09

(57) ABSTRACT

The present invention is related to liquid compositions, kits and to methods for using thereof such as for reducing pathogen load or for prolonging shelf-life of the edible matter.

### CROSS REFERENCE TO RELATED APPLICATIONS

This application claims the benefit of priority under 35 U.S.C. § 119(e) of U.S. Provisional Patent Application No. 63/061,346, filed on Aug. 5, 2020, the content of which is incorporated by reference as if fully set forth herein in its entirety.

### FIELD OF THE INVENTION

The present invention relates to the field of compositions and methods for prolonging shelf-life and for reducing pathogen load on or within the edible matter (e.g. plants and/or plant parts). Particularly, the invention relates to a liquid coating composition for protecting fruits during storage against pathogens or decay, and against losses of gustatory properties.

### BACKGROUND OF THE INVENTION

Fresh agricultural produce, including fruits and vegetables, remain as living tissues and undergo metabolism even after harvest. Their nutritional value, microbial safety, flavor and appearance, deteriorate during storage and transport due to ripening, water loss, microbial damages, and postharvest storage damages. As a result, even with modern day preservation techniques, an extreme amount of valuable food is lost or its commercial value decreases. It is estimated that about 40% of all food intended for human consumption end up as waste in developed countries. Reducing the losses will increase food availability and promote environmental sustainability.

Consequently, attempts to reduce food losses and maintain the quality of fresh products for a longer period are of high priority. There are several approaches to assure the safety and quality of fresh produce. Temperature is the most important environmental factor that influences the deterioration of postharvest produce, effecting internal and external factors including spore germination and pathogens formation. The storage temperature effects the ripening period and the shelf-life. Temperature and humidity affect water losses during storage. It is therefore highly important to maintain adequate postharvest storage conditions.

For thousands of years the avocado and mango, climacteric fruits, have had an important place in human diets, increasing in global importance over the years. However, they have a short shelf-life and are sensitive to phytopathogenic fungi, such as Colletotrichum gloesporioides or Lasiodiplodia theobromae. Low temperature storage limits the pest invasion problems, but too low temperature may result in chilling injuries, such as surface pitting, appearance of black spots, and internal browning. Maintaining the optimum storage temperature, for example 5-13° C. for unripe avocados and 10-12° C. for mango, may be difficult.

Stricter regulations for using chemicals in food, as well as an increased demand for minimally processed food products, poses major challenges in the food industry. Attempts of employing edible coatings on fruits and vegetables address the requirements for reducing the use of chemicals and also plastic packaging. Edible coatings are thin layers of biodegradable components applied on postharvest fruits, functioning as blockers to moisture and oxygen without affecting original components of the fruits. Edible coatings may protect food from mechanical, physical, chemical, and microbial damages, while preventing the escape of advantageous volatiles and maintaining aesthetic appearance of the product. Edible coatings are usually based on edible materials, preferably from natural sources, while using water as a solvent. However, edible coatings are sometimes adequate only for a certain type of fruit, and the components must be carefully selected to ensure flawless adhesion, high microbial protection, appropriate gas and moisture exchange properties, and importantly visual and gustatory features—all within a reasonable price. Various polysaccharide-based coatings comply with the mentioned requirements. It is therefore an object of this invention to provide an edible coating based on polysaccharides for protecting fruits, particularly avocado and mango fruits.

### SUMMARY OF THE INVENTION

This invention provides an aqueous composition for producing an edible coating that reduces decay of fruits and maintains their quality, comprising an edible polysaccharide and phenylalanine or a salt thereof, preferably said polysaccharide has a concentration of from 0.1 to 4 wt %, and said phenylalanine has a concentration of from 1 mM to 20 mM. Particularly, this invention provides an aqueous composition for producing an edible coating that reduces decay of fruits and maintains their quality, comprising a polysaccharide selected from derivatives of cellulose or chitosan in a concentration of 0.2 to 4.0 wt %, such as from 0.2 to 2.0 wt %, and phenylalanine or a salt thereof in a concentration of 0.02 to 0.3 wt %, such as from 0.02 to 0.2 wt %. Said polysaccharide may be selected from carboxymethyl cellulose (CMC), methyl cellulose (MC), hydroxypropyl methylcellulose (HPMC), and chitosan.

The composition may comprise additives selected from preservatives, pH adjusters, and viscosity adjusters, and other agents enhancing the stability of the components or improving the working properties of the whole mixture. The preservatives may comprise bacteriostatic or fungistatic agents, or insect repellents. Some agents, coat efficiency assisters, improve the efficiency of the composition, for example by improving the compactness of the coating on the fruit surface before or after drying, or by ensuring flawless adhesion, or by enhancing mechanical barriers to microbial attacks. The composition of the invention comprises in some embodiments coat efficiency assisters selected from fatty acids or salts thereof. In a preferred embodiment of the invention, the composition for producing an edible fruit coating comprises stearic acid as a coat efficiency assister employed, preferably, with CMC. In some embodiments, the composition comprises derivatives of cellulose or chitosan, such as CMC or chitosan, in a concentration of 0.5 to 2.0 wt %, such as from 0.5 to 1.5 wt %, and phenylalanine or a salt thereof in a concentration of 0.05 to 0.2 wt %, such as 0.05 to 0.1 wt %. In one preferred embodiment, the composition of the invention comprises derivatives of chitosan in a concentration of 0.2 to 4.0 wt %, such as 0.5 to 1.5 wt %, and phenylalanine or a salt thereof in a concentration of 0.05 to 0.3 wt %, such as 0.05 to 0.1 wt %. In another preferred embodiment of the invention, the composition comprises derivatives of cellulose, such as for example CMC, in a concentration of 0.2 to 4.0 wt %, such as 0.5 to 1.5 wt %, phenylalanine or a salt thereof in a concentration of 0.05 to 0.3 wt %, and stearic acid or a salt thereof in a concentration of 0.25 to 2.0 wt %, such as 0.5 to 1.0 wt %. Said edible coating is produced, in the present invention, by spraying, dipping, or spreading of said aqueous composition on the surface of said fruits, followed by drying. The composition of the invention may be employed for protecting various fruits. In a preferred embodiment the protected fruits are selected from tropical and subtropical fruits. In one embodiment, said fruit belongs among orders Sapindales or Laurales; for example, said fruit is avocado or mango.

The invention relates to a method of protecting fruit against decay and maintaining its quality during storage, comprising i) providing an aqueous composition comprising a polysaccharide selected from derivatives of cellulose or chitosan in a concentration of 0.2 to 4.0 wt %, and phenylalanine or a salt thereof in a concentration of 0.02 to 0.3 wt %, and an additive selected from preservatives, coat efficiency assisters, pH adjusters, and viscosity adjusters in a concentration of from 0.25 to 2.0 wt %; and ii) forming a layer of said aqueous composition in the surface of said fruit and removing water from said layer by drying. Various known drying methods may be employed, including employing air tunnels. The method of the invention achieves still better results in maintaining the visual, olfactory, and gustatory properties of the fruit after harvest, when storing said fruit at a temperature lower than ambient. In another embodiment of the invention, the method further comprises storing said fruit in an artificial atmosphere, employing the known effects of various gases for specific fruit species.

The invention provides a coating for prolonging the shelf-life of fruit comprising a polysaccharide selected from derivatives of cellulose or chitosan in a concentration of 0.2 to 4.0 wt %, and phenylalanine or a salt thereof in a concentration of 0.02 to 0.3 wt %.

### BRIEF DESCRIPTION OF THE DRAWINGS

The above and other characteristics and advantages of the invention will be more readily apparent through the following examples, and with reference to the appended drawings, wherein:

FIGS. 1A-1B show the effects of different polysaccharides based edible coatings on decay and quality of ‘Ettinger’ avocado fruit; Data presented were assessed after 14 d at 22° C.; the graphs show the data of day 14 for, calyx browning and black spots (FIG. 1A); and stem end rot severity evaluated on a 0-3 scale (FIG. 1B). the presented data are means of estimations obtained from 24 fruit per treatment, the error bars represent standard error (S.E);

FIGS. 2A-2D show the effects of different polysaccharides based edible coatings, with (+) and without (−) Phe, on ‘Fuerte’ avocados physiology. (FIG. 2A) weight loss (percentage). (FIG. 2B) Firmness (Newton). (FIG. 2C) Ethylene levels for 9 d. (FIG. 2D) CO₂ levels for 4 d. Values followed by different letters are significantly different (p<0.05);

FIGS. 3A-3D show the effects of different polysaccharides based edible coatings, with (+) and without (−) Phe, on ‘Fuerte’ avocados pathology. (FIG. 3A) Total decay incidence (percentage). (FIG. 3B) Side decay severity (index 0-3). (FIG. 3C) Stem-end rot severity (index 0-3). (FIG. 3D) Representative pictures at the end of the experiment (day 12). Values followed by different letters are significantly different statistically (p<0.05);

FIGS. 4A-4D show the effects of different polysaccharides based edible coatings, with (+) and without (−) Phe, in different storage temperatures on ‘Ettinger’ avocados stem-end rot and chilling injuries. The fruit was stored for 21 d at 2° C. or 5° C., followed by one week at 22° C. (FIG. 4A and FIG. 4B). Chilling injuries (index 0-3). (FIG. 4C and FIG. 4D). Stem end rot severity (index 0-3);

FIGS. 5A-5B show the different polysaccharides based edible coatings, with (+) and without (−) Phe on ‘Ettinger’ avocados flavor. (FIG. 5A) ‘Fuerte’ avocados were store for 12 d at 22° C. (FIG. 5B) ‘Ettinger’ avocados were stored for 21 d at 2° C., followed by one week at 22° C. The data presented were assessed on the last d of the experiment. The fruit flavor was evaluated on an index of 0-5; and

FIGS. 6A-6B show the relative expression of genes in peel tissue of ‘Ettinger’ fruit coated with chitosan, with or without Phe in response to chilling. ‘Ettinger’ fruit coated with chitosan, with or without Phe and stored for 21 d at 2° C., after the cold storage the relative expression was evaluated. (FIG. 6A) Relative expression of genes related to cold-response (LOX: Lipoxygenase, HSP: heat shock protein, FAD: fatty acid desaturase). (FIG. 6B) Relative expression of genes related to the biosynthesis of phenylpropanoids (F3H: flavone-3-hydroxylase, FLS: flavonol synthase, 4CL: 4-Coumarate coenzyme A ligase). Different letters indicate significance of P<0.05.

### DETAILED DESCRIPTION OF THE INVENTION

It is another object of this invention to provide an edible coating for prolonging storage periods of fruits even at temperatures outside the optimal ranges.

It is still another object of this invention to provide a cost-effective method of storing fruits while ensuring their nutritional value, microbial safety, flavor, taste, and appearance during a prolonged shelf-life.

It is a further object of this invention to provide a cost-effective method of prolonging the shelf-life of fruits while maintaining their visual and gustatory properties even outside the optimal ranges of temperature and humidity.

It is a still further object of this invention to provide an edible coating for protecting fruits during prolonged storage against phytopathogenic fungi.

In some embodiments, this invention aims at providing a method for storing fruits, particularly mango and avocado, while reducing the use of chemicals and eventually of plastic packaging.

In some embodiments, this invention aims at providing an edible coating for protecting fruits during prolonged storage and for maintaining their aesthetic and gustatory properties.

In some embodiments, this invention aims at providing an edible coating for prolonging shelf-life of fruits, exhibiting good adhesion and ensuring microbial protection, while maintaining visual and gustatory features of the fruits.

In some embodiments, this invention aims at providing a cost-effective method for manufacturing an edible coating for prolonging shelf-life of fruits.

### Composition

In one aspect of the invention provided herein, there is a composition comprising an effective amount of a polysaccharide and/or a salt thereof; and phenylalanine (Phe) and/or a salt thereof.

In some embodiments, the composition of the invention (e.g. a liquid coating composition) is formulated for coating application on top of the edible matter. In some embodiments, the coating of the invention is characterized by gas permeability. In some embodiments, the coating of the invention when applied on the edible matter doesn't substantially affect respiration of the edible matter (e.g. of a plant and/or a plant part, such as fruit, root, stem, leaf, etc.)

In some embodiments, the coating of the invention is a liquid coating or a liquid composition. In some embodiments, the composition of the invention is liquid at a a temperature above 1° C., above 5° C., above 10° C., above 20° C., above 30° C., above 70° C., or more including any range between.

In some embodiments, the composition of the invention comprises food-grade active components (e.g. a food-grade polysaccharide). In some embodiments, the composition of the invention comprises a single polysaccharide or a plurality of distinct polysaccharide species. In some embodiments, the effective amount of the polysaccharide; and of Phe and/or a salt thereof, is a food-acceptable amount (e.g. in the diluted ready-to-use coating composition). In some embodiments, the composition solely comprises food-acceptable ingredients.

In some embodiments, the composition of the invention comprises a synergistically effective amount of the polysaccharide and phenylalanine (Phe). In some embodiments, the composition of the invention is an antimicrobial composition comprising antimicrobial effective amount of polysaccharide and Phe. In some embodiments, the synergistically effective amount is the antimicrobial effective amount. In some embodiments, the synergistically effective amount is sufficient for (i) reduction of pathogen load on or within the edible matter, compared to a control; and/or for (ii) prolonging shelf-life (and as a consequence, reducing decay of the edible matter).

In some embodiments, the effective amount comprises synergistically effective amount of the polysaccharide and of Phe, wherein the synergistically effective amount is sufficient for preventing and/or reducing pathogen load on or within the edible matter, for a time period described herein. In some embodiments, the synergistically effective amount comprises a w/w ratio of the polysaccharide to Phe (including any salt thereof) of between 10:1 and 1:1; between 10:1 and 8:1; between 8:1 and 6:1; between 6:1 and 4:1; between 5:1 and 3:1; between 2:1 and 1:1; between 1:1 and 1:3; including any range or value therebetween.

In some embodiments, the synergistically effective amount comprises a w/w ratio of the polysaccharide to Phe (including any salt thereof) of between 50:1 and 1:1; between 50:1 and 40:1; between 40:1 and 30:1; between 30:1 and 20:1; between 20:1 and 10:1; between 10:1 and 1:1 including any range or value therebetween.

In some embodiments, the synergistically effective amount comprises a w/w ratio of the polysaccharide to Phe (including any salt thereof) of between 1:1 and 1:3; between 1:3 and 1:5; between 1:3 and 1:10; including any range or value therebetween.

In some embodiments, the effective amount comprises the w/w concentration of the polysaccharide between 0.1 and 10%, or between 0.2 and 4% including any range between; and further comprising the w/w concentration of Phe between 0.01 and 1%, between 0.02 and 0.3%, or between 0.3 and 0.5%, between 0.5 and 1% including any range between.

In some embodiments, the composition is characterized by an acidic pH. In some embodiments, the composition is characterized by neutral pH. In some embodiments, the composition is characterized by pH of less than 7, less than 6.5, less than 6, less than 5, less than 4, including any range or value therebetween. In some embodiments, the composition is characterized by pH of between 2 and 7, between 2 and 7, between 2 and 4, between 4 and 5, between 5 and 6, including any range or value therebetween. In some embodiments, the pH of the composition is adjusted so as to allow complete dissolution of the active ingredients therewithin.

In some embodiments, the composition comprises a solvent. In some embodiments, the solvent is sufficient for substantially dissolving or dispersing the components of the composition. In some embodiments, the composition is a solution or a suspension. In some embodiments, the solvent is capable of dissolving the polysaccharide and Phe. In some embodiments, the amount of the solvent is sufficient for forming a solution of the polysaccharide and Phe.

In some embodiments, the solvent is a water-miscible solvent. In some embodiments, the solvent is a polar organic solvent. In some embodiments, the solvent is an aqueous solvent. In some embodiments, the aqueous solvent comprises water and optionally a salt (e.g. a buffering agent). In some embodiments, the solvent comprises an aqueous solvent and a water miscible organic solvent.

In some embodiments, the composition is an aqueous composition (e.g. an aqueous solution) having at least 10%, 20%, 30%, 40%, 50%, 60%, 70%, 80%, 90%, 95%, 98% or 99% water by weight, including any range between.

In some embodiments, the terms “effective amount” and “synergistically effective amount” are used herein interchangeably.

In some embodiments, the polysaccharide is or comprises a negatively or positively charged polysaccharide. In some embodiments, the polysaccharide is or comprises a chemically modified polysaccharide. In some embodiments, the polysaccharide is water soluble or water dispersible.

In some embodiments, the water solubility of the polysaccharide is at least 0.1 g/L, at least 0.5 g/L, at least 1 g/L, at least 5 g/L, at least 10 g/L, at least 50 g/L, at least 100 g/L, including any range between.

In some embodiments, the polysaccharide is or comprises a cellulose derivative. In some embodiments, the polysaccharide is or comprises a water-soluble cellulose derivative. In some embodiments, the polysaccharide is selected from carboxylated cellulose, alkylcarboxylated cellulose (e.g. carboxymethyl cellulose (CMC)), alkyl cellulose (e.g. methyl cellulose (MC), ethyl cellulose, hydroxypropyl methylcellulose (HPMC)), or any combination thereof. In some embodiments, the polysaccharide is or comprises any of cellulose, pectin, alginate, and chitosan including any combination thereof. In some embodiments, the polysaccharide is or comprises chitosan (e.g. at least partially deacetylated chitosan). In some embodiments, the polysaccharide of the invention is or comprises chitosan, a cellulose derivative or both. In some embodiments, the polysaccharide of the invention is or comprises chitosan, cellulose a cellulose derivative or a combination thereof.

In some embodiments, the derivative, as used herein is referred to a structural isomer and/or to a chemical derivative of any of the herein disclosed polysaccharides and/or Phe. In some embodiments, the derivative is a biologically active derivative having an anti-pathogenic activity.

In some embodiments, the composition comprises a food-acceptable salt of the polysaccharide and/or of Phe.

In some embodiments, the polysaccharide and/or any salt thereof (e.g. chitosan, or a cellulose derivative), and Phe and/or any salt thereof compose between 50 and 99.9%, between 50 and 70%, between 70 and 80%, between 80 and 90%, between 90 and 95%, between 95 and 99.9%, by weight of the active ingredients of the composition of the invention, including any range or value therebetween.

In some embodiments, the active ingredients of the composition refer to any compound required for obtaining a synergistic antimicrobial or anti-pathogenic effect, as described herein. In some embodiments, the active ingredients of the composition refer to any compound required for providing the edible matter related coating effect (e.g. antimicrobial effect).

In some embodiments, the composition of the invention is or comprises a dilutable composition, wherein dilutable comprises dilution up to 10 times, up to 30 times, up to 50 times, up to 100 times, up to 500 times, up to 1000 times, up to 10000 times, including any range or value therebetween. In some embodiments, the composition of the invention is stable upon dilution by a dilution factor ranging between 2 and 10000, including any range or value therebetween.

As used herein the term “stable” is referred to the chemical stability and/or physical stability of the composition of the invention. In some embodiments, a composition is referred to as “stable” if it substantially retains its chemical composition upon storage under appropriate storage conditions. In some embodiments, a composition is referred to as “stable” if it substantially retains its physical appearance (e.g. state of matter) and is substantially devoid of phase separation, precipitation, aggregation, agglomeration or turbidity under appropriate storage conditions. In some embodiments, appropriate storage conditions comprise a temperature of between 1 and 60° C. In some embodiments, appropriate storage conditions comprise ambient atmosphere (air-, CO2-, and/or nitrogen atmosphere). In some embodiments, appropriate storage conditions comprise storage time of at least 1 month (m), at least 2 m, at least 3 m, at least 4 m, at least 5 m, at least 6 m, at least 7 m, at least 8 m, at least 10 m, at least 12 m, at least 24 m, at least 36 m, at least 48 m, at least 72 m, including any range or value therebetween. In some embodiments, the term “stable” refers to a storage stability of the composition, wherein storage stability comprises stability under appropriate storage conditions, as described herein.

In some embodiments, the composition is referred as stable, if the concentration of the polysaccharide and/or Phe within the composition decreases by not more than 1% over 6 months at a temperature below 20° C.

In some embodiments, the composition described herein is related to a concentrate which is optionally diluted (e.g. prior to application), so as to obtain the above-mentioned concentration of any one of the active ingredients.

In some embodiments, the effective amount of the polysaccharide (including any salt thereof) comprises a weight per weight (w/w) concentration of the polysaccharide within the composition of the invention (e.g. the concentrate) from 0.2 to 80%, from 5 to 10%, from 5 to 8%, from 7 to 9%, from 10 to 15%, from 15 to 20%, from 20 to 25%, from 25 to 30%, from 30 to 40%, from 40 to 50%, from 50 to 60%, from 60 to 80%, including any range or value therebetween. One skilled artisan will appreciate, that the exact concentration of the polysaccharide within the composition may vary, depending on the aqueous solubility/dispersibility thereof.

In some embodiments, the effective amount of phenylalanine (including any salt thereof) comprises a w/w concentration of phenylalanine within the composition of the invention (e.g. the concentrate) is from 0.02 to 30%, from 0.02 to 0.05%, from 0.05 to 0.1%, from 0.1 to 0.5%, from 0.5 to 1%, from 1 to 5%, from 5 to 10%, from 10 to 15%, from 15 to 20%, from 20 to 25%, from 25 to 30%, from 30 to 90%, from 30 to 35%, from 35 to 40%, from 40 to 45%, from 45 to 50%, from 50 to 55%, from 55 to 60%, from 60 to 65%, from 65 to 70%, from 70 to 80%, from 80 to 90%, from 90 to 95%, including any range therebetween.

As used herein, the term coating composition refers to a diluted (ready to use) antimicrobial composition comprising an effective amount (e.g. antimicrobial effective amount) of any of the active ingredients disclosed herein. In some embodiments, the coating composition of the invention comprises synergistically effective amount of any of the active ingredients, as described herein. In some embodiments, the coating composition comprises a food-acceptable concentration of any one of the active ingredients.

In some embodiments, an effective amount comprises a w/w concentration of the polysaccharide within the coating composition of the invention is from 0.1 to 10%, from 0.1 to 4%, from 4 to 10%, from 4.1 to 10%, from 0.1 to 0.3%, from 0.1 to 0.2%, from 0.2 to 10%, from 0.2 to 0.3%, from 0.3 to 0.5%, from 0.5 to 1%, from 1 to 2%, from 2 to 3%, from 3 to 4%, including any range or value therebetween.

In some embodiments, an effective amount comprises a w/w concentration of the polysaccharide within the coating composition of the invention as described herein and further comprises a w/w concentration of Phe within the coating composition of the invention is from 0.01 to 1%, from 0.01 to 0.02%, from 0.02 to 0.05%, from 0.05 to 0.1%, from 0.1 to 0.3%, from 0.1 to 0.2%, from 0.2 to 0.3%, from 0.3 to 0.50%, from 0.5 to 1b %, from 1 to 2%, including any range or value therebetween.

In some embodiments, an effective amount comprises a w/w concentration of the polysaccharide within the coating composition of the invention of between 0.5 to 2.0%, including any range or value therebetween; and a w/w concentration of Phe within the coating composition of the invention between 0.05 and 0.2% including any range or value therebetween.

In some embodiments, any of the compositions disclosed herein further comprises a carrier. In some embodiments, any of the compositions disclosed herein further comprises a food-acceptable carrier. In some embodiments, the carrier comprises a carrier gas, an aqueous solvent, a surfactant, an additive, and a stabilizer or any combination thereof.

In some embodiments, any of the compositions disclosed herein further comprises a surfactant. In some embodiments, the surfactant is selected from the group consisting of: a non-ionic surfactant, an anionic surfactant, a cationic surfactant and an amphoteric surfactant or any combination thereof.

Non-limiting examples of anionic surfactants include but are not limited to: (C6-C8) alkyl-sulfate and/or sulfonate (e.g., sodium or potassium lauryl sulfate, sodium or potassium dodecyl sulfate), fatty alcohol ether sulfate salt (e.g., (C12-C14)alkyl-O—(CH2CH2O)2-SO3-, ZOHARPON ETA 27), polyacrylate (e.g., sodium or potassium polyacrylates), or any combination thereof.

Non-limiting examples of non-ionic surfactants include but are not limited to: alkyl-polyglycoside (e.g., Triton CG 110, APG 810), polyethyleneglycol-(C11-C15)alkyl-ether (such as Imbentin AGS/35), alkoxylated fatty alcohol (such as Plurafac LF221), or any combination thereof.

In some embodiments, the surfactant is selected from the group consisting of: Plurafac LF221, a polyacrylate, Triton CG 110, APG 810, ZOHARPON ETA 27, Imbentin AGS/35, Plurafac LF221, Disponil or any combination thereof.

In some embodiments, the composition of the invention further comprises a stabilizer. In some embodiments, the composition of the invention further comprises an additive. In some embodiments, the additive is selected from the group consisting of: an organic additive (e.g., a scent or an odorant, a colorant, a pigment, an anti-freeze agent), an anti-foaming agent, an inorganic salt, an acid (e.g. a C1-C30, or C8-C20 fatty acid or a salt thereof), a base, and a buffering agent or any combination thereof. In some embodiments, the additive comprises fatty acid or a salt thereof. In some embodiments, the additive comprises any of a preservative, a coat efficiency assister, a pH adjuster, and a viscosity adjuster. Such additives are well known in the art.

In some embodiments, a w/w concentration of an additive within the composition is from 0.1 to 10%, from 0.1 to 5%, from 0.1 to 3%, from 0.1 to 2%, from 0.1 to 1%, including any range therebetween.

In some embodiments, the composition of the invention is in form of spray (e.g. an aerosol spray), and/or a fogger that creates fine micro droplets from 0.1 to 10 micron further comprising a carrier gas. In some embodiments, the composition of the invention is formulated for spray application, and comprises from 0.1 to 10% w/w of a surfactant, wherein the surfactant is as described herein.

Non-limiting examples of carrier gas include but are not limited to: hydrogen, nitrogen, helium, argon or carbon dioxide, or any combination thereof.

The coating compositions of the present invention can be in a variety of forms including aqueous solutions, suspensions, gels, foams, fogs, and sprays. The disinfectant or coating compositions can also be used as disinfectant fogs and disinfectant mists.

The compositions disclosed herein can be manufactured as dilute ready-to-use compositions, or as concentrates that can be diluted prior to use. The various compositions may also include fragrances, depending on the nature of the product.

In some embodiments, the coating composition of the present invention can be formulated into a disinfectant foam or foaming composition. The disinfectant foams or foaming compositions include the coating composition of the invention and foaming agents. Any foaming agent known in the art can be used depending on the desired application and characteristics of the resulting disinfectant foam.

In some embodiments, the coating composition of the present invention can be in the form of a disinfectant aerosol or a fog. In some embodiments, the coating composition of the present invention is formulated for dip coating application, and is substantially devoid of a surfactant.

In some embodiments, the coating composition is formulated for application on the surface of the edible matter (e.g. a plant and/or a plant part such as fruit, stem, root, etc.).

### Kit

In another aspect, the present invention provides a kit for combined preparations. In one embodiment, a “combined preparation” defines especially a “kit of parts” in the sense that the combination partners as described herein can be dosed independently or by use of different fixed combinations with distinguished amounts of the combination partners i.e., simultaneously, concurrently, separately or sequentially. In some embodiments, the parts of the kit of parts can then, e.g., be used simultaneously or chronologically staggered, that is at different time points and with equal or different time intervals for any part of the kit of parts. The ratio of the total amounts of the combination partners, in some embodiments, can be used in the combined preparation.

In another aspect of the invention, there is a kit comprising a first composition comprising the polysaccharide, a salt thereof, or both; and a second composition comprising Phe a salt thereof, or both. In some embodiments, a w/w concentration of the polysaccharide, a salt thereof, or both within the first composition is between 0.1 and 90%, between 0.1 and 4%, between 4 and 10%, between 10 and 50%, between 50 and 70%, between 60 and 65%, between 65 and 70%, between 70 and 90%, including any range or value therebetween. In some embodiments, a w/w concentration of Phe a salt thereof, or both within the second composition is between 0.01 and 99%, between 0.01 and 0.05%, between 0.05 and 0.1%, between 0.1 and 1%, between 1 and 4%, between 0.1 and 4%, between 4 and 10%, between 10 and 50%, between 50 and 70%, between 60 and 65%, between 65 and 70%, between 70 and 90%, including any range or value therebetween. In some embodiments, the first composition and/or the second composition is/are aqueous composition(s) (e.g. solution or dispersions). In some embodiments, the first composition and/or the second composition of the kit comprises an aqueous solvent.

In some embodiments, a w/w ratio between (i) the polysaccharide, a salt thereof, or both; and (ii) Phe a salt thereof, or both within the kit a synergistically effective ratio, as described herein. In some embodiments, the synergistically effective ratio between (i) and (ii) a salt thereof within the kit is between 20:1 and 10:1; between 20:1 and 15:1; between 15:1 and 10:1; between 10:1 and 1:1 including any range or value therebetween. In some embodiments, a synergistically effective ratio is so as to result (e.g. upon mixing of the first composition with the second composition, and optionally upon further dilution) in the coating composition of the invention comprising an effective amount (e.g. antimicrobial effective amount) of (i) and (ii), as described herein.

In some embodiments, the first composition, the second composition or both are stable for a time period of at least 1 month, at least 6 months, at least 1 year, at least 2 years, including any range or value therebetween. In some embodiments, first composition, the second composition or both are stable under storage conditions, as described herein.

In some embodiments, the kit comprises instructions for mixing the first composition and the second composition of the kit so as to obtain the coating composition of the invention comprising an effective amount of the active ingredients as described herein. In some embodiments, the kit comprises instructions for mixing of the first component and of the second component at a predetermined ratio, and optionally further diluting the mixture, so as to obtain the coating composition of the invention (e.g. comprising the w/w concentration of the polysaccharide between 0.1 and 10%, or between 0.2 and 4%; and further comprising the w/w concentration of Phe between 0.01 and 1%, or between 0.02 and 0.3% including any range between).

In some embodiments, the first composition and the second components of the kit are mixed together at least 10 seconds, at least 1 hour (h), at least 10 h, at least 24 h, at least 48 h before use (e.g. application to the edible matter), including any range between. In some embodiments, mixing is as described hereinbelow.

In some embodiments, the first composition of the kit and the second composition of the kit are mixed together up to 24 h, up to 48 h, or up to 72 h before use of the composition. In some embodiments, mixing comprises dosing the first composition and the second composition in an amount sufficient for obtaining a predetermined molar and/or weight ratio of (i) and (ii) within the coating composition.

In some embodiments, dosing comprises dispensing a predetermined amount of the first composition and a predetermined amount of the second composition and subsequent mixing thereof, so as to obtain a predetermined concentration of the active ingredients within the composition, wherein the active ingredients are as described hereinabove. In some embodiments, dosing is by inducing homogenous dilution of the mixture. In some embodiments, dosing is by continuous injection of any one of the components of the composition within the delivery system. In some embodiments, dosing is by a metering pump. In some embodiments, the delivery system comprises delivery pipeline (e.g. water pipe).

In some embodiments, at least one of the first composition and the second composition further comprises an agent selected from the group consisting of: a surfactant, an additive, and a stabilizer or any combination thereof, wherein the surfactant, the additive and the stabilizer are as described hereinabove, and wherein a concentration of the additive within the first and/or the second composition is between 0.01 and 20%, between 0.01 and 0.1%, between 0.1 and 2%, between 2 and 10%, between 10 and 20%, including any range between.

In some embodiments, the first composition, the second composition, or both is stable for at least 6 months.

### Article

In another aspect of the invention, there is an edible matter in contact with the kit or the composition of the invention. In some embodiments, at least one surface of the edible matter is in contact with a solid composition comprising the active ingredients and optionally one or more additives, as described hereinabove. In some embodiments, the edible matter is in contact with a solid composition comprising (i) the polysaccharide, a salt thereof, or both; and (ii) Phe a salt thereof, or both. In some embodiments, the edible matter is in contact with a solid composition as described herein, wherein a w/w ratio between (i) and (ii) is between 100:1 and 80:1; between 80:1 and 50:1; between 50:1 and 30:1; between 30:1 and 20:1; between 20:1 and 10:1; between 20:1 and 15:1; between 15:1 and 10:1; between 10:1 and 1:1, or between 1:1 and 1:10; including any range or value therebetween.

In some embodiments, the kit, the composition of the invention, or the solid composition is on top of at least one surface of the edible matter. In some embodiments, the kit, the composition of the invention, or the solid composition is in contact with or bound to (e.g. non-covalently bound, and/or adsorbed) at least one surface of the edible matter. In some embodiments, the kit, the composition of the invention, or the solid composition on top of the surface of the edible matter, is in a form of a coating. In some embodiments, the coating is in a form of a continuous layer. In some embodiments, the coating comprises multiple layers.

In some embodiments, the term “edible matter” encompasses any plant and/or a plant part, such as fruit, seed, leaves, stem, root, bulb, grains, sprouts, nuts, or any combination thereof. In some embodiments, the term “edible matter” encompasses any plant-based or plant-related product or article.

Non-limiting example of edible matter include but are not limited to: apple, avocado, citrus (e.g. clementine, orange, grapefruit, lemon), date, kiwi, lychee, mango, peach, pear, persimmon, pomegranate, pepper, asparagus, banana, broccoli, cabbage, carrot, cauliflower, celery, corn, kohlrabi, cucumber, eggplant, garlic, lettuce, onion, peanut, potato, strawberry, sweet pepper, sweet potato, tomato, watermelon, and grape or any combination thereof.

### Method

In another aspect of the invention, there is a method for (i) prolonging shelf-life of the edible matter, (ii) reducing pathogen load of the edible matter, or both (i) and (ii). In some embodiments, the method comprises contacting the edible matter with an effective amount of the coating composition of the invention under suitable conditions. In some embodiments, the suitable conditions are sufficient for reducing pathogen load and/or prolonging shelf-life of the edible matter. In some embodiments, the effective amount comprises antimicrobial effective amount, as described herein.

In some embodiments, the method is for reducing pathogen load on a surface of the edible matter. In some embodiments, the method is for reducing pathogen load within the edible matter. In some embodiments, the method is for preventing pathogen formation on or within the edible matter.

In some embodiments, the method is for prolonging shelf-life of the edible matter. In some embodiments, prolonging shelf-life comprises reducing decay (e.g. dehydration and/or pathogen-related decay) of the edible matter. In some embodiments, prolonging shelf-life comprises substantially maintaining the appearance and/or sensory properties of the edible matter, wherein maintaining refers to the appearance and/or sensory properties of fresh edible matter (e.g. fresh fruits). In some embodiments, prolonging and/or reducing are as described herein.

In some embodiments, the method comprises providing an edible matter; and contacting the edible matter with an effective amount of the coating composition of the invention or with an effective amount of the kit of the invention.

In some embodiments, the method comprises providing a edible matter; and contacting the edible matter with the coating composition of the invention comprising the effective amount of the polysaccharide and of Phe, as described herein.

In some embodiments, contacting is performed under conditions sufficient for reducing pathogen load on or within the edible matter and/or for prolonging shelf-life of the edible matter. In some embodiments, the pathogen load is as described hereinbelow.

In some embodiments, suitable conditions (e.g. sufficient for reducing pathogen load) comprise contacting time sufficient for reducing the pathogen load on the edible matter. In some embodiments, suitable conditions comprise contacting time for at least 0.1 min, at least 0.1 min, at least 0.1 min, at least 0.1 min, at least 0.2 min, at least 0.3 min, at least 0.4 min, at least 0.5 min, at least 0.6 min, at least 0.7 min, at least 0.8 min, at least 0.9 min, at least 1 min, at least 2 min, at least 3 min, including any range or value therebetween.

Without being limited to any particular theory, it is presumed that the contacting time is predefined by the effective concertation of the active ingredients within the coating composition of the invention, for example lower concertation requires longer contacting time and vice versa.

In some embodiments, contacting is at a temperature between 1 and 60° C., between 10 and 50° C., between 15 and 40° C., between 10 and 30° C., between 20 and 60° C., between 20 and 30° C., between 20 and 40° C., including any range or value therebetween.

In some embodiments, contacting is at a temperature between 10 and 90° C., between 10 and 50° C., between 50 and 90° C., between 50 and 60° C., between 60 and 70° C., between 70 and 80° C., between 80 and 90° C., including any range or value therebetween.

In some embodiments, the effective amount of the coating composition is such that at a contact time of one minute at a temperature of more than 10° C., more than 15° C., more than 20° C., more than 25° C., more than 30° C., more than 35° C., more than 40° C., the coating composition results in reduction of colony forming units (CFU) of a pathogen on or within the edible matter by a factor of between 10 and 1,000,000; between 10 and 100; between 100 and 1,000; between 1000 and 100,000; between 100,000 and 1,000,000; including any range or value therebetween, as compared to a non-treated edible matter, wherein the pathogen is as described hereinabove.

In some embodiments, the method comprises contacting the edible matter with an effective amount of the coating composition for at least 30 seconds at a temperature of more than 10° C., more than 15° C., more than 20° C., more than 25° C., more than 30° C., more than 35° C., more than 40° C., more than 50° C., more than 60° C., thereby reducing pathogen load on or within the edible matter by a factor of at least 10,000, of at least 100,000, of at least 1,000,000, including any value or arrange therebetween. In some embodiments, the method is for preventing pathogen growth on or within the edible matter for at least 5 days (d), at least 10 d, at least 15 d, at least 20 d, at least 30 d, at least 40 d, at least 50 d, when stored at a temperature between 5 and 60° C., or between 5 and 20° C., or between 20 and 60° C., including any value or arrange therebetween. In some embodiments, the effective amount of the coating composition is such that at a contact time of at least 30 seconds at a temperature of more than 10° C., more than 15° C., more than 20° C., more than 25° C., more than 30° C., more than 35° C., more than 40° C., more than 50° C., more than 60° C., the coating composition results in reduction of CFU of a pathogen on or within the edible matter by a factor of 10 to 1,000,000 as compared to a non-treated edible matter.

In some embodiments, the effective amount refers to the concentration and/or w/w ratio of the active ingredients within the coating composition of the invention, as described hereinabove.

As used herein, the terms “controlling” and “reducing” are used interchangeably and are related to reduction of colony forming unit (CFU)/cm² on the edible matter surface, as compared to a non-treated edible matter surface, by a factor of between 2 and 10, between 10 and 100, between 100 and 1000, between 1000 and 10,000, between 10,000 and 100,000, between 100,000 and 1,000,000, including any range between.

In some embodiments, the method is for reducing pathogenic activity on or within the edible matter.

As used herein, the term “reducing pathogenic activity” refers to the ability to inhibit, prevent, reduce or retard bacterial growth, fungal growth, biofilm formation or eradication of living bacterial cells, or their spores, or fungal cells or viruses in a suspension, on or within the edible matter, or in a moist environment, or any combination thereof. In some embodiments, inhibition or reduction or retardation of biofilm formation by a pathogen positively correlates with inhibition or reduction or retardation of growth of the pathogen and/or eradication of a portion or all of an existing population of pathogens.

In some embodiments, the method of the invention comprises reducing CFU/cm² on the edible matter surface at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated edible matter surface.

In some embodiments, the method of the invention comprises reducing CFU on or within the edible matter at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated edible matter surface. In some embodiments, the method of the invention comprises inhibiting or eradicating pathogen load on or within the edible matter, wherein inhibiting or eradicating comprise complete arrest of pathogen growth and/or complete eradication of the initial pathogen load.

Colonies start as single pathogen (CFU) which multiplies and forms a colony. Given enough CFUs close by, eventually, neighboring colonies will fuse. Increasing the magnification allows detection of micro-colonies before they fuse. In some embodiments, “colony” as used herein, refer to a colony observed by the naked eye. In some embodiments, “pathogen”, as used herein, refer to a microorganism such as bacteria and/or fungi.

In some embodiments, the method is for preventing or inhibiting pathogen load in or within the edible matter. In some embodiments, the method is for preventing pathogen infection of the edible matter at a storage temperature of above 25° C. during a time period of at least 3 d, 5 d, 10 days (d), at least 15 d, at least 12 d, at least 17 d, at least 20 d, at least 22 d, at least 25 d, at least 27 d, at least 30 d, at least 35 d, at least 40 d, including any range or value therebetween.

In some embodiments, the method is for preventing pathogen infection of the edible matter at a storage temperature of below 15° C. during a time period of at least 1 month (m), at least 1 month (m), at least 2 m, at least 3 m, at least 4 m, at least 5 m, at least 6 m, at least 7 m, at least 8 m, at least 10 m, at least 12 m, including any range or value therebetween.

In some embodiments, the method of the invention is for reducing edible matter decay. In some embodiments, edible matter decay comprises decay related to the pathogen load of the edible matter. In some embodiments, edible matter decay comprises decay related to common biological processes occurring within the harvested edible mater, such as dehydration, cell death, etc. As used herein, the term “reducing” comprises decay reduction of the edible matter treated by a coating composition of the invention, as compared to a non-treated edible matter, wherein reduction is by a factor of between 2 and 10, between 10 and 100, between 100 and 1000, between 1000 and 10,000, including any range between.

In some embodiments, the method is for enhancing or prolonging storage stability and/or extending shelf life, relative to untreated edible matter. In some embodiments, enhancing or prolonging is by at least 20%, at least 50%, at least 100%, at least 200%, at least 500%, at least 1000%, including any range between.

In some embodiments, edible matter decay is selected from the group consisting of: loss from pathogen load, decomposing, sprouting, loss from a disease, rotting, dehydration, and blackheart formation, loss from a higher organism or any combination thereof.

In some embodiments, the coating composition is applied at one or more stages in a life-cycle of the edible matter (such as seeding, foliage, flowering, post-harvest, harvest, pre-harvest etc.). In some embodiments, the coating composition is applied to a harvested fruit and/or vegetable. In some embodiments, the coating composition is applied to a pre-harvest or post-harvest edible matter. In some embodiments, the coating composition is applied to a processed fruit and/or vegetable, wherein processed comprises any food processing technique, such as cooking, slicing, etc.

Non-limiting example of pathogens include but are not limited to: cryophiles, nematodes, mites, ticks, fungi, algae, mold, bacteria, viruses, spores, yeast, and Bacteriophages or any combination thereof.

In some embodiments, the pathogen is selected from the group consisting of: bacteria, a fungus, a yeast, a virus, an algae, a mold, protozoa, an amoeba, and spore-propagating microorganisms or any combination thereof.

In some embodiments, bacteria are selected from the group consisting of gram-positive bacteria. In some embodiments, the gram-positive bacteria are selected from the group consisting of Staphylococcus, Streptococcus, Enterococcus, Bacillus, Corynebacterium, Nocardia, Clostridium, Actinobacteria and Listeria or any combination thereof.

In some embodiments, bacteria are selected from the group consisting of gram-negative bacteria. In some embodiments, the gram-negative bacteria are selected from the group consisting of Escherichia, Salmonella, Shigella, Enterobacteriaceae, Pseudomonas, Moraxella, Helicobacter, Stenotrophomonas, Bdellovibrio, acetic acid bacteria, Legionella, cyanobacteria, spirochaetes, green sulfur bacteria, green non-sulfur bacteria, and respiratory symptoms Moraxella or any combination thereof.

In some embodiments, bacteria are selected from the group consisting of Escherichia coli, Staphylococcus aureus, Pseudomonas aeruginosa and Enterococcus hirae or any combination thereof.

In some embodiments, the fungus is selected from the group consisting of Magnaporthe, Ophiostoma, Cryphonectria, Fusarium, Ustilago, Alternaria, Cochliobolus, Aspergillus, Candida, Cryptococcus, Histoplasma, and Pneumocytis or any combination thereof.

In some embodiments, the yeast is selected from the group consisting of Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae and Rhodotorula mucilaginosa or any combination thereof.

In some embodiments, the virus is selected from the group consisting of Adenoviruses, Herpesviruses, Poxviruses, Parvoviruses, Reoviruses, Picornaviruses, Togaviruses, Orthomyxoviruses, Rhabdoviruses, Retroviruses and Hepadnaviruses or any combination thereof.

In some embodiments, the method is for preventing biofilm formation on the substrate. In some embodiments, the method is for inhibiting biofilm formation. In some embodiments, the method is for reducing existing biofilms. In some embodiments, the method is for breaking-down existing biofilms.

As used herein the term “biofilm” refers to any three-dimensional, matrix-encased microbial community displaying multicellular characteristics. Accordingly, as used herein, the term biofilm includes surface-associated biofilms. Biofilms may comprise a single microbial species or may be mixed species complexes, and may include bacteria, or other microorganisms.

In some embodiments, the biofilm is essentially nullified or is reduced by at least 20%, at least 30%, at least 40%, at least 50%, at least 60%, at least 70%, at least 80%, at least 90%, including any value therebetween. Unless otherwise indicated, the word “or” in the specification and claims is considered to be the inclusive “or” rather than the exclusive or, and indicates at least one of, or any combination of items it conjoins.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

Other terms as used herein are meant to be defined by their well-known meanings in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Other objects and advantages of present invention will appear as the description proceeds.

It has now been found that the presence of phenylalanine in a protective coating improves the stability of fruit (e.g., mango and avocado) during storage. The combination of an edible coating with phenylalanine as an active agent significantly improved the stability of fresh postharvest fruits when compared to uncoated fruit, and also when compared to fruit coated with the edible coating without the active agent.

Without wishing to be limited by any particular theory, the inventors believe that phenylalanine may act as an elicitor on fresh fruits, since they comprise living tissues and undergo metabolic reactions, as mentioned above, particularly in view of the fact that phenylpropanoids broadly produced in plants from tyrosine and phenylalanine are associated with plant defense. The inventors have studied the effects of phenylalanine incorporated into edible coatings and found that it markedly improves the performance of edible coatings during storage of fruits.

Screening of various materials was performed in order to identify the suitable coating matrices for climacteric fruits (e.g., avocado and mango). Chitosan and carboxymethyl cellulose with stearic acid (CMC+SA) markedly inhibited fruit spoilage. The strong adhesion of these coatings to the fruit, provided fruit with the most aesthetic appearance due to the homogeneity and stability of the matrices and the high structural integrity during storage.

Phenylalanine was examined as a protective agent in the coatings based on chitosan or CMC+SA applied on avocado fruit stored for 12 days at 20° C. The following parameters were examined: decay, firmness, weight loss, flavor, and atmosphere analysis. It was observed that the polysaccharides alone reduced the decay extent, whereas the phenylalanine addition further enhanced the protection effect. Phenylalanine alone did not show clear protection effects. The coated fruits showed higher firmness compared to the untreated control, with the exception of fruit coated with only phenylalanine (control with phenylalanine). The addition of phenylalanine to the coatings markedly increased the firmness, phenylalanine alone not. The coating with CMC+SA and phenylalanine provided the highest firmness. All coated fruits had lower weight loss compared to the control, whereas CMC+SA and phenylalanine provided the lowest weight loss. Interestingly, a clear trend was observed to the reduced weight loss with the phenylalanine addition. In a sensorial study, the coatings provided better flavor compared to the control, whereas CMC+SA with phenylalanine showed the best flavor. The addition of phenylalanine into the avocados coating seemed to slower the ripening process, to enhance the resistance to decay, and to provide better flavor.

One of the known problems faced upon applying edible coatings on fruit is their eventual negative effect on gas permeation, affecting normal CO2/O2 exchange and possibly resulting in the formation of off-flavoring volatiles. To test for the permeability, CO2 levels were examined, and to test for markers of the off-flavoring volatiles, acetaldehyde and ethanol levels were examined. Only insignificant amounts of the off-flavoring volatiles was observed in the examined coatings. The examined treatments did not harm fruit respiration, nor led to fermentation processes. Finally, the effect of the tested coatings on ethylene emission was examined, and it was found that all coated fruits showed a delay in the ethylene emission peak, in accordance with the observed slowdown in the ripening process. Thus, the tested coatings had a beneficial influence on avocado gas permeation, showing a delayed ethylene peak, a lower CO2 emission, and no off-flavoring volatiles.

The coating formulations according to the invention were also applied on avocados stored under various temperature regimens, including initial storage at minimal recommended temperature, 5° C., followed by 20° C. for shelf-life storage, or alternatively at a reduced temperature condition of 2° C. to study chilling injury, followed by 20° C. for shelf-life storage. The decay was reduced in comparison with the control for all coatings, the effect being enhanced by phenylalanine in the coating, in both temperature regimens. There was a notable trend of reducing weight loss and improving firmness due to the presence of phenylalanine, particularly at the reduced storage temperature of 2° C. Surface pitting and internal browning were decreased by the phenylalanine presence, particularly under the reduced temperature storage. Chitosan with phenylalanine provided the best results.

The sensory evaluations also confirmed the markedly positive effect of the coatings and still more of including phenylalanine in the coats, wherein chitosan with phenylalanine provided the best results.

A series of various polysaccharide-based coatings confirmed the benign effect of phenylalanine included in the coatings, for example chitosan coating or CM+SA coating, wherein the added phenylalanine slows down the decay during storage and improves organoleptic properties in the treated avocado and mango. The coatings with phenylalanine also showed an ability to decrease chilling injury and to advantageously employ lower storage temperatures.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The invention will be further described and illustrated by the following examples.

### EXAMPLES

Materials and Methods

Plant Material

Mango fruits from ‘Keitt’ cultivar were obtained from a packing house at Almagor, 2018. ‘Ettinger’ and ‘Fuerte’ avocados were obtained from ‘Granot avocado packing house’, a commercial packing house in Granot, Israel. On the day of harvest, the fruit were transferred to the Department of Postharvest Science in the Volcani Institute, where they were cleaned by dipping in tap water for 10 seconds, and air dried at 20° C. for 1 hour.

### Preparing Edible Formulations for Coating

CMC sodium salt was purchased from Alfa Aesar (Heysham, LA32XY, England). 0.5 gr CMC powder was dissolved in 50 ml sterilized water upon stirring at 80° C. for two hours to obtain a 1% (w/v) solution. HPMC was purchased from Alfa Aesar (Ward Hill, Mass. 01835 USA). 0.5 g HPMC powder was dissolved in 50 ml sterilized water upon stirring at 80° C. for four hours to obtain a 1% (w/v) solution.

Methylcellulose (MC) of 400 cPs viscosity was purchased from Alfa Aesar (Ward Hill, Mass. 01835, USA). 0.5 15 g MC powder was dissolved in 50 ml sterilized water upon stirring at 50-60° C. for two hours to obtain a 1% (w/v) solution.

Low molecular weight chitosan (100-300 cPs) was purchased from Glentham Life Science (United Kingdom). 0.5 g chitosan powder was dissolved in 50 ml sterilized water that included 0.5% (v/v) of acetic acid upon stirring at room temperature to obtain a 1% (w/v) solutions.

Chitosan solution, 50 ml, as described above was mixed with 0.033 g phenylalanine to obtain a formulation of 1% chitosan (w/v) with 4 mM phenylalanine.

CMC sodium salt was purchased from Alfa Aesar (Heysham, LA32XY, England). 0.5 g CMC powder was dissolved in 49 ml sterilized water upon stirring at 80° C. for two hours. 0.3 g stearic acid (Sigma-Aldrich, St Louis, Mo., USA) was dissolved in 1 ml of ethanol, that included 50 μl of TWEEN 80 (Sigma-Aldrich, St Louis, Mo. 63103, USA) upon stirring at 70° C. for one hour. CMC and stearic acid solutions were mixed to a total volume of 50 ml and homogenized for five minutes to obtain a formulation of 1% CMC (w/v) with 0.6% (w/v) of stearic acid (CMC+SA).

A solution of CMC+SA, 50 ml, as described above was mixed with 0.033 g phenylalanine to obtain a formulation of 1% CMC (w/v), 0.6% (w/v), and stearic acid with 4 mM phenylalanine.

Alginic acid was purchased from Sigma-Aldrich (St Louis, Mo. 63103, USA). 0.5 g alginic acid powder was dissolved in 50 ml sterilized water upon stirring at 70° C. for two hours to obtain a 1% (w/v) solution. 60 g CaCl₂) (Calcium chloride dihydrate, Merck Germany) was dissolved in 1200 ml sterilized water upon stirring. The avocados were coated with the alginate coating solution, dried, and then dipped in the CaCl₂) solution for 30 seconds.

### Experimental Design

Three series of experiments were conducted. In each experiment the coated avocados were compared with uncoated fruits. The first experiment included seven edible coating formulations: carboxymethyl cellulose (CMC) (1% w/v), methylcellulose (MC) (1% w/v), hydroxypropyl methylcellulose (HPMC) (1% w/v), chitosan (1% w/v), alginate (1% w/v), and CMC with stearic acid (CMC+SA) (1% w/v and 0.6% w/v, respectively). The second, and third experiments included five edible coating formulations including phenylalanine, chitosan, CMC+SA, chitosan with phenylalanine, and CMC+SA with phenylalanine. In experiments 1-2 each treatment group included 8 avocados kept in cardboard boxes. In these experiments the fruit were stored for 14 and 12 days respectively at 20° C. (shelf-life conditions). In experiment 3 each treatment group included 14 avocados kept in cardboard boxes. The formulations of the edible coatings were applied to the fruit using paintbrushes. The uncoated fruit was treated similarly with sterilized water. Then, the coated and uncoated fruit was dried in a drying tunnel with forced air at 23° C. The fruit was then stored at 5° C. for optimal cold storage and at 2° C. for sub-optimal temperature, for 21 d each, followed by 7 d at 22° C.

### Fruit Quality Studies

General: At the end of each storage period fruit quality parameters were examined. Measurements of fruit firmness, weight loss, atmosphere analysis and sensory evaluations were performed.

Fruit firmness: It was evaluated by using an electronic penetrometer force gauge LTLutron FG-20KG (Indonesia) with an 11 mm probe at two points on the equatorial line of each fruit (20 measurements/treatment). The results are presented in Newton units and are means±S.E. of measurements obtained from 8 randomly chosen fruit per treatment.

Weight loss: Fruit weight loss was calculated by weighing the same fruit, before and after storage, and the results are presented as percentages of weight loss. The presented results are means±S.E. of measurements obtained from 8 randomly chosen fruit per treatment.

Volatiles' analysis: The avocados were stored in open glassed jars, one jar per fruit, three replicate jars of each treatment, for nine days at 22° C. (shelf-life conditions). On days 0, 1, 2, 4, 8, and 9 the jars were closed for one hour. Then, 0.005 L of gas was sampled from each jar into gas-syringes. To evaluate the respiration rate, CO₂ emission levels were examined. Carbon dioxide (CO₂) concentration was determined using a Shimadzu gas chromatography (GC) equipped with a thermal conductivity detector (GOW-MAC instruments Co. Series 580, PA, USA) with a double-column CTR-1 (Altech, 6 ft×¼ in.), carrier gas helium, oven temperature 30° C. (Lichter et al, 2005). To test for off-flavoring volatiles, acetaldehyde (AA) and ethanol (EtOH) levels were determined using a Varian 3300 GC (Walnut Creek, Calif., USA) equipped with a flame ionization detector and 20% Carbowax 20 M packed column using helium as the carrier gas. Ethylene emission was determined using a GC with a flame ionization detector (FID) (Varian 3300; Walnut Creek, Calif., USA) using packed alumina column (Altech 4 ft×⅛ in.), carrier gas helium, oven temperature 85° C., injection temperature 75° C., detector temperature 155° C. (Perez et al, 2004). The presented results are means S.E. of measurements obtained from three randomly chosen fruit per treatment. CO₂ was calculated by using equation 1:

$$\frac{1.84 * C * V}{100 * W * h} = {co}_{2 ( mg / g * h )}$$

1.84=Converting factor, from volume to grams
h=Number of hours the jar was closed [one hour]
100=converting units to grams
C=GC result (%)
V=Free volume in the jar (ml)
W=Sample weight (gr)

Ethylene, acetaldehyde and ethanol were calculated by using equation 2:

$$\frac{C * V}{W * h} = Ethylene / EtOH / {AA}_{( nl / g * h )}$$

C=GC result (ppm)
V=Free volume in the jar (ml)
W=Sample weight (gr)
h=Number of hours the jar was closed [one hour]

Sensory evaluation: Fruit sensory quality was evaluated by a panel of 15 panelists at the end of experiments 2 and 3. In all cases, fruits were hand-peeled, cut and placed in white plastic plates, identified by randomly assigned three-letter codes. Each treatment comprised a pooled mixture of six cut segments from six different fruits, for evaluation by each panelist. Sensory acceptance was evaluated according to a 0-5 scale ranging from “fruit without taste or aroma” to “very tasteful or aromatic fruit”.

Stem end rot: Stem end rot was determined at the end of each experiment by assessing the visual appearance of the fruit stem end. Stem end rot was evaluated on a 0-3 scale, in which 0=no stem end rot and 3=dark black rot. The presented results are means±S.E. of measurements obtained from 10 randomly chosen fruit per treatment.

Side rot: Side rot was determined at the end of each experiment by assessing the visual appearance of the fruit side. Side rot was evaluated on a 0-3 scale, in which 0=no side rot and 3=dark black rot. The presented results are means S.E. of measurements obtained from 10 randomly chosen fruit per treatment.

Calyx browning: Calyx browning was determined at the end of each experiment by assessing the visual appearance of the fruit calyx. Calyx browning was evaluated on a 0-3 scale, in which 0=no calyx browning and 3=dark browning. The presented results are means±S.E. of measurements obtained from 10 randomly chosen fruit per treatment.

Appearance of black spots: Appearance of black spots was determined at the end of each experiment by assessing the visual appearance of the fruit. Appearance of black spots was evaluated on a 0-3 scale, in which 0=no black spots and 3=plenty of black spots. The presented results are means±S.E. of measurements obtained from randomly chosen fruit per treatment.

Determination of decay incidences: Stem end rot (SER) was determined at the end of each experiment by assessing the visual appearance of the fruit stem end. SER was evaluated on a 0-3 scale, in which zero=no SER and three=severe SER. The presented results are the means±S.E. of measurements.

Side rot (Alternaria rot and anthracnose) was evaluated at the end of each experiment on a 0-3 scale, in which zero=no side rot and three=severe rot. The presented results are the means S.E. of measurements.

Total decay incidences were determined by calculating the percentage of decayed fruit at the end of each experiment per treatment. The results are presented as means±S.E of percentages of decay incidences of rotten avocados fruit per treatment.

Internal browning: Internal browning was determined by cutting each fruit for half, lengthwise, at the end of each experiment, and assessing the visual appearance of the fruit Internal browning. Internal browning was evaluated on a 0-3 scale, in which 0=no internal browning and 3=sever internal browning. The presented results are means S.E. of measurements obtained from randomly chosen fruit per treatment.

RNA extraction and transcript relative expression (Quantitative PCR; qPCR): Avocado peel tissue was collected from avocado fruit controls and from chitosan or chitosan+Phe treatments 21 d after cold storage at 2° C. Total RNA was extracted from avocado peel tissue according to the methodology proposed by Djami-Tchatchou and Straker (2012). Then, total RNA was treated with DNase (TURBO DNA-free Kit, Ambion Life Technologies, USA) according to the manufacturer's instructions. Total RNA (1e⁻⁶ g) was used for cDNA construction using the RevertAid First-Strand cDNA Synthesis kit (Thermo Scientific, USA) according to the manufacturer's instructions. cDNA samples were diluted 1:10 to the final template concentration and used for qRT-PCR. The relative expression of genes related to cold response encoding omega-3-fatty acid desaturase 7 (FAD7; FD505476.1), heat-shock protein (HSP II 17.6; CK748339.1) and lipoxygenase (LOX; FD505476.1) and the relative expression of phenylpropanoid-related genes encoding flavone-3-hydroxylase (F3H; EU335680.1), flavonol synthase (FLS; UN28880) and 4-Coumarate coenzyme A ligase (4CL; UN30532) was evaluated by qRT-PCR analysis conducted with a Step One Plus Real-Time PCR (Applied Biosystems, USA). PCR amplification was performed with 3.4e⁻⁶ L of diluted cDNA template in 1e⁻⁵ L reaction mixture containing 5e⁻⁶ L Sybr Green (Applied Biosystems) and 300 nM primers. qRT-PCR analysis was conducted with the corresponding primer sets of the selected genes: forward, 5′-CACAGGACGCATCACCAGAA-3′ (SEQ ID NO: 1) and reverse, 5′-TGCGGGAAACATCATCCAA-3′ (SEQ ID NO: 2) for FAD7, forward, 5′-AGGCGATGGCGTCAACTC-3′ (SEQ ID NO: 3) and reverse, 5′-CCTCTCGCCGCTAATTACCA-3′ (SEQ ID NO: 4) for HSP II 17.6, forward, 5′-AAGGCTCGGTGGTGTTGATG-3′ (SEQ ID NO: 5) and reverse, 5′-TCGCCATGTTCTGCACTGA-3′ (SEQ ID NO: 6) for LOX, forward, 5′-AGTTGAGGCGGGTCTGATTT-3′ (SEQ ID NO: 7) and reverse, 5′-TCCCTTCTTCCCTCCAGACAT-3′ (SEQ ID NO: 8) for F3H, forward, 5′-GCCCACACGGACATGAGT-3′ (SEQ ID NO: 9) and reverse, 5′-GGCCACCAGTTCCCATCTTTC-3′ (SEQ ID NO: 10) for FLS, forward, 5′-GGCGGGTTCGGAAGAAACAC-3′ (SEQ ID NO: 11) and reverse, 5′-GCCCTCCCATCATACTGGATTC-3′ (SEQ ID NO: 12) for 4CL, and forward, 5′-AGCTCGCTTATGTGGCTCTTGACT-3′ (SEQ ID NO: 13) and reverse, 5′-TCTCATGGATTCCAGCAGCTTCCA-3′ (SEQ ID NO: 14) for the housekeeping actin gene. PCR was carried out using the following cycling program: 10 min at 94° C., followed by 40 cycles of 94° C. for 10 s, 60° C. for 15 s, and 72° C. for 20 s. The expression of the selected genes was normalized to that of actin and the relative expression was calculated using a relative standard curve with Step One software v2.2.2 (Applied Biosystems). Each treatment consisted of three biological repeats and three technical replicates.

Statistical analysis: Microsoft Excel spreadsheets were used to calculate means and standard deviation for all statistical analysis. One-way analysis of variance (ANOVA) and Tukey's HSD pairwise comparison tests were applied by means of the JMP statistical software program, version 10 (Statistical Discovery™ from SAS, Cary, N.C., USA).

### Example 1

### Identification of Suitable Polysaccharides-Base Edible-Coatings for Fruit

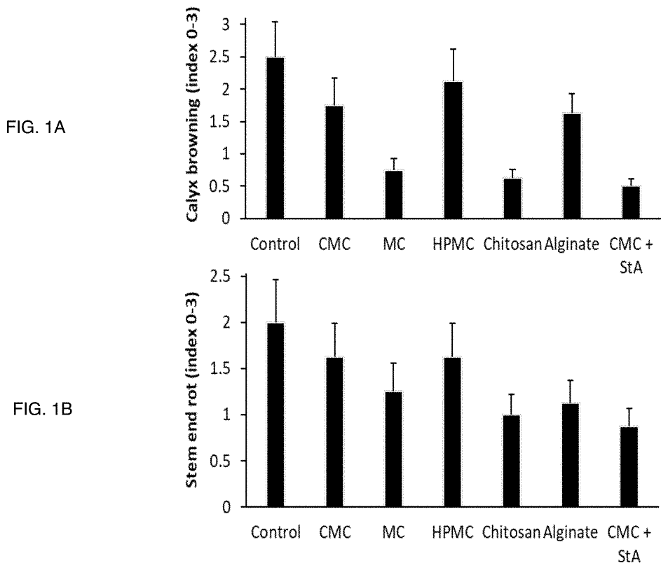

An initial screening of various materials was performed in order to identify the best coating matrices for avocado fruit. Carboxymethyl cellulose (CMC), methylcellulose (MC), hydroxypropylmethyl-cellulose (HPMC), chitosan, alginate and carboxymethyl cellulose with stearic acid (CMC+StA) were applied on avocados, and the fruit was stored for 14 d at 20° C. The uncoated fruit was used as a control. At the end of the storage period, the quality and decay of avocados coated by different edible coatings were studied. It was found that among the various coatings, chitosan and CMC+StA coatings provided fruit with the lowest SER and calyx browning (FIG. 1). These results indicate that CMC+StA and chitosan inhibit fruit ripening. It is known that as the avocado fruit ripens, it becomes more susceptible to decay and stem-end rot (SER). These two coatings also benefit from strong adhesion and provide avocado fruit with the most esthetic appearance due to the good homogeneity and the high structural integrity of the matrices during storage.

### Example 2

### Effect of the Addition of Phe into the Coatings

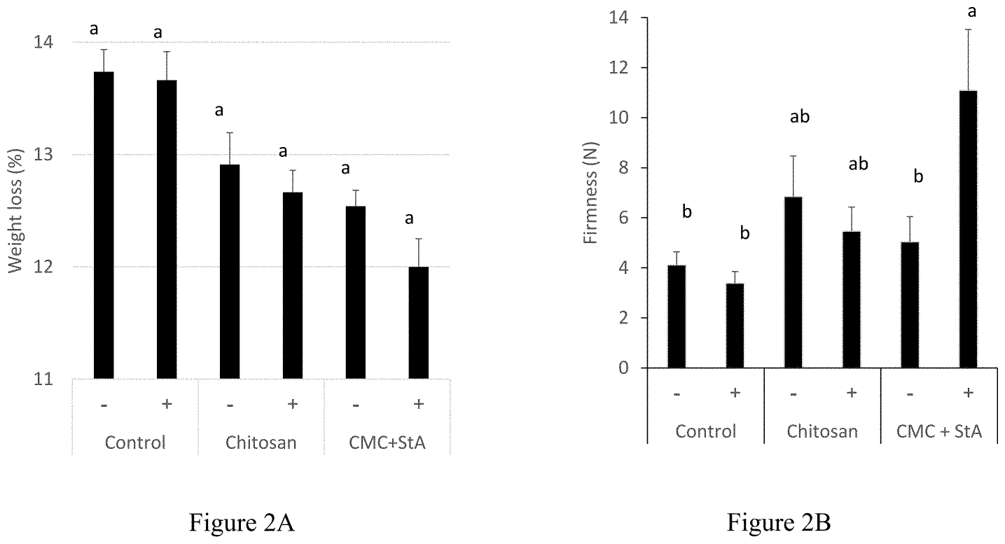

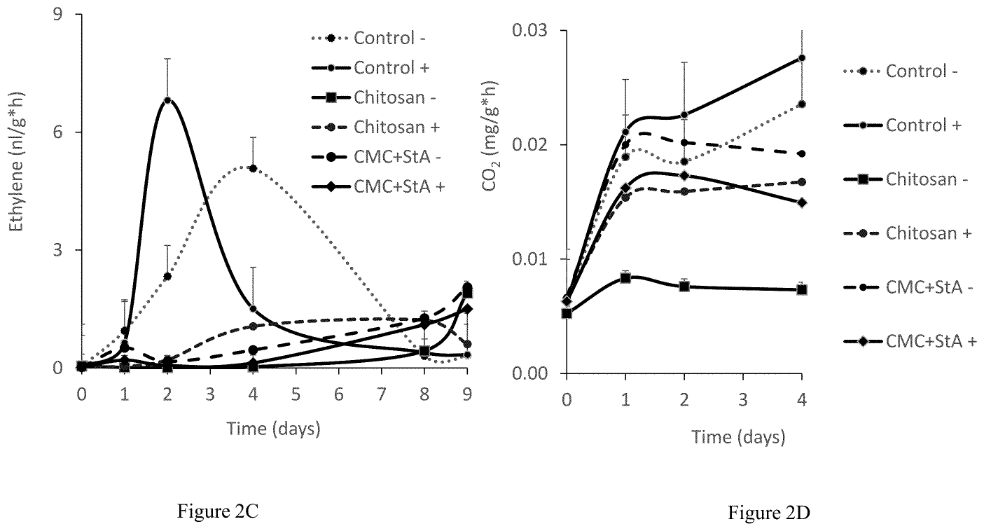

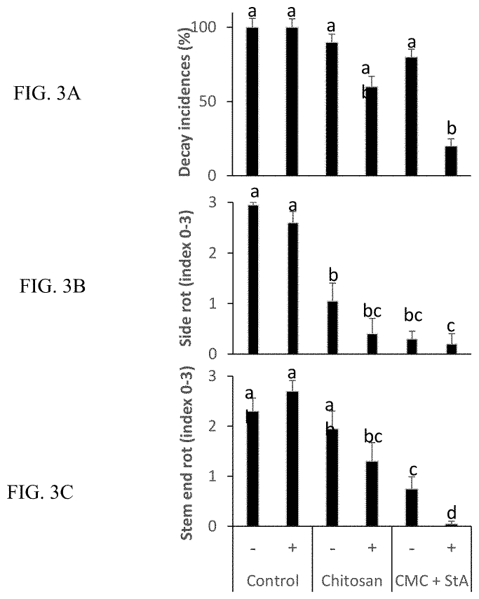

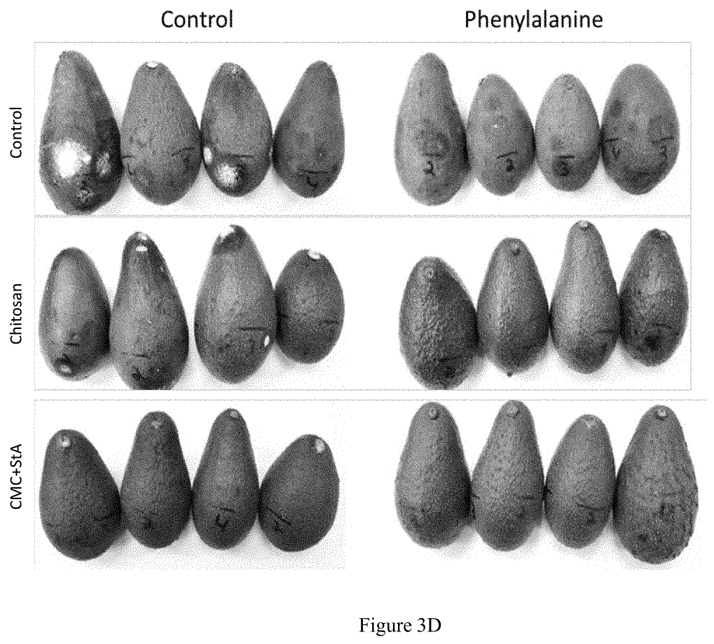

With the aim of utilizing the beneficial performance of phenylpropanoids on the fruit self-defense mechanism, Phe was examined as a defense response inducer additive. In the present study, Phe was added to the chosen polysaccharide-base coating formulations, chitosan, and CMC+StA, and the resulting coating solutions were applied on avocado fruit that was stored for 12 d at 22° C. The storage period was two days shorter than the previous experiment since the fruit that was harvested later in the session, decayed faster. At the end of the storage period, the following parameters were examined: decay, firmness, weight loss, and volatiles analysis (FIGS. 2, 3).

One of the main problems faced upon applying edible coatings on fruit is their negative effect on gas permeation. Lack of permeability, or low levels of permeability, affects CO₂/O₂ exchange that modifies the internal atmosphere of the fruit, resulting in accumulation of CO₂ and stimulation of anaerobic respiration. This anaerobic respiration may encourage the accumulation of off-flavoring volatiles. To test the effect of coating on gas permeability, the CO₂ levels and off-flavoring markers, acetaldehyde, and ethanol, volatiles levels were examined. Relatively low amounts of the off-flavoring volatiles were detected in all examined coatings and the control, meaning the tested coatings do not increase respiration as detected by the CO₂ level (FIG. 2d), and the anaerobic respiration as detected by off-flavor markers levels. Notably, CO₂ levels in chitosan-coated fruit were the lowest throughout the experiment, whereas no significant influence was observed due to the account of adding Phe to the coatings. The examined treatments did not harm the fruit respiration nor caused fermentation, while the coating reduced CO₂ levels and water loss (FIGS. 2d, 2a). These findings strengthen their candidacy for use as coatings on fresh produce. During climacteric fruit ripening, ethylene levels rise to a certain peak, representing the ‘climacteric peak’ (Kadam and Salunkhe, 1995). Thus, the effect of the tested coatings on ethylene emission was examined. In the present study, it was found that all fruit coated delayed the ethylene emission in comparison to the control and the treatment with Phe alone (FIG. 2c), leading to a later onset of the fruit ripening. Indeed, all coated fruit demonstrated a non-significant improved firmness (FIG. 2b). The addition of Phe to the coatings highly increased the firmness in the CMC+StA coating. In this treatment of CMC+StA and Phe the fruit was the firmest. All coated fruit had less weight loss compared to the control, while fruit coated with CMC+StA and Phe had the lowest weight loss percentage (FIG. 2a). There is a clear trend of reduction in weight loss with the addition of the Phe to each of the tested coatings (FIG. 3a).

It was observed that the combination of Phe and polysaccharide coating matrix enhances the beneficial effect and significantly reduced decay incidence of both stem-end rot and side rot. The addition of Phe without coating matrix or the coating without Phe had some effect on reducing fruit decay incidence and severity (FIG. 3). However, the combination of coating with Phe led to a very significant reduction of decay incidence and severity. Thus, the fruit that was coated with CMC+StA and Phe had almost no decay (FIG. 3).

### Example 3

### Storage in Optimal and Suboptimal Temperature Conditions

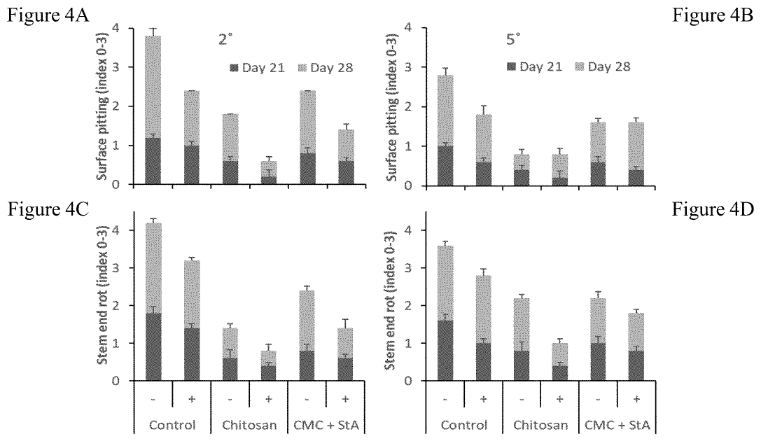

The chosen coating formulations were applied on avocados, and the avocado fruit were stored for 21 d in optimal (5° C.) and sub-optimal (2° C.) temperature conditions, followed by 22° C. for mimicking shelf-life storage. Blackening and pitting of the skin surface, as well as internal browning, were assessed to measure chilling injury. The appearance of black spots was not observed in both storage conditions throughout the experiment. Concerning surface pitting, coatings containing Phe decreased the severity of this symptom, particularly in sub-optimal temperature storage conditions. Chitosan with Phe appears as the best treatment (FIG. 4a). Internal browning was overall low in this experiment. However, it should be mentioned that the coating slightly increased the internal browning, while the combination with Phe reduced it significantly.

Both coating and Phe application reduced the appearance of chilling injuries, while the combination of chitosan and Phe had the most significant reduction in chilling injuries symptoms (FIG. 4). Additionally, all treatments reduced decay in comparison to the control with a clear beneficial effect of the added Phe in both storage conditions (FIG. 4c, d). The combination of the polysaccharide coatings and Phe gave the best results, chitosan with Phe being the most efficient treatment. No calyx browning was observed in 5° C. (data not shown). Edible coating and modified atmosphere are known to reduce chilling injuries in harvested fruit. Additionally, the phenylpropanoid pathway is a known defense response against chilling. Here, it is the first report that shows that postharvest application of Phe to fruit could reduce the chilling injuries symptoms. It can be determined that the addition of Phe to the coatings had a valuable part in enhancing the fruit defense mechanism, leading to avocados with a significantly reduced decay and chilling incidences.

The firmness improvement due to the polysaccharide coating can be unambiguously observed, especially in reduced temperature storage conditions, proving the productivity of the coatings in these conditions. Perhaps the delayed ripening that was found in fruit stored at a lower temperature of 2° C. lead to a more apparent effect.

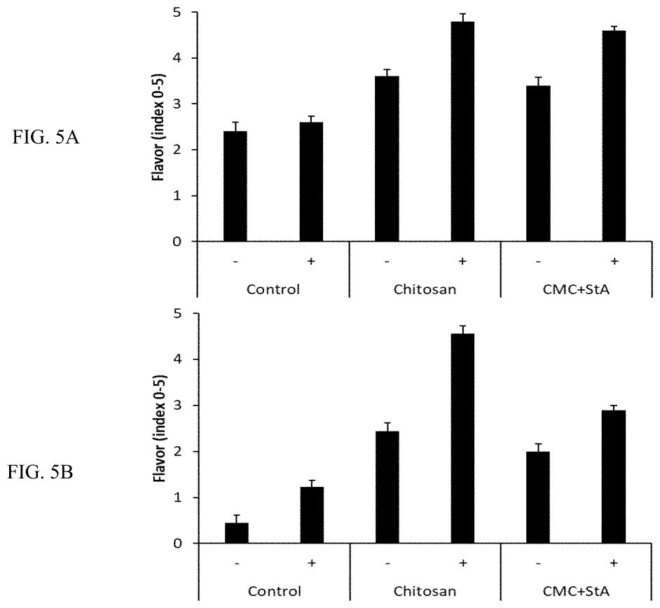

In accordance with these results, in a sensory evaluation that was conducted, all coated fruit had a better flavor than the untreated control (FIG. 5b). While the coated fruit containing Phe was marked to have the best flavor among all, chitosan with Phe rated the highest (FIG. 5b). This sensory evaluation was conducted on fruit that was stored in 2° C. in order to examine whether the beneficial effect of the added Phe influenced the fruits' flavor as well as induced the defense response to the biotic (fungal pathogen) and the abiotic (chilling) stress. It is presumed that the application of Phe enhanced the phenylpropanoid pathway, resulting in higher flavonols and secondary metabolites in fruit that led to fruit with better flavor.

The same sensorial study that was conducted in the previous section, all treatments were marked to have better flavor compared to the control, while fruit treated with polysaccharides containing with Phe (chitosan with Phe, CMC+StA with Phe) were marked to have the best flavor among all (FIG. 5a). Presumably, the addition of Phe into the coatings enhanced the induced defense response related to phenylpropanoid pathway and various secondary metabolites in the examined avocados, resulting in fruit with lower decay incidences and better flavor, having flavonoids being synthesized from Phe in this process. Flavonoids play a major role in plant resistance. As an example, red mango fruit with enhanced flavonoid contents shows improved resistance to fungal pathogens and better cold.

Flavonoids and their related secondary metabolite are known to play a role in flower fragrance. Flavonoids are unique bioactive compounds that also contribute to the organoleptic profile, hence improving the fruits' flavor. The increase in Phe or the application of Phe increased the flavonoid content in leaves, which correlated with reducing gray mold. Similarly, in our experiment, we applied Phe to fruit and show for the first time that the application of Phe to the fruit increased its resistance to postharvest decay in avocado fruit (FIG. 5a). Although the trend is almost completely the same, the minor difference within the results of the sensorial evaluations that have been tested in this section (FIG. 5b) and in the previous section (FIG. 5a) might be due to storage conditions and differences among the examined cultivars.

### Example 4

### Evaluation of the Relative Gene Expression

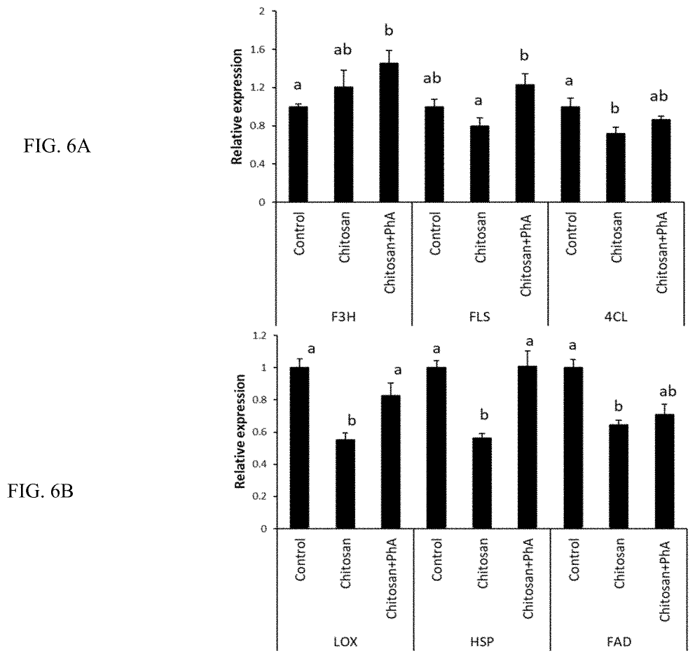

To understand the effect of chitosan coatings, with and without Phe, on avocado fruit's response to chilling and on fruit defense response, we evaluated the relative expression of genes that are known to be induced in response to chilling [Lipoxigenase (LOX), Heat shock protein (HSP) and fatty acid desaturase (FAD)], and genes involved in biosynthesis of phenylpropanoids [flavanone-3-hydroxylase (F3H), flavonol synthase (FLS) and 4-coumarate-CoA ligase (4CL)]. The relative expression of the genes was assessed by quantities PCR (qPCR) on avocado fruit that was stored at a sub-optimal temperature at 2° C. for 21 d. The stress-responsive genes LOX, HSP and FAD are known as biochemical markers for postharvest chilling stress response in various fruit and vegetables. HSP increases chilling resistance in fruit by stabilizing the membrane and scavenging radicals. FAD is induced by cold stress and converts membrane saturated fatty-acids (FA) to unsaturated FA. Thus, it maintains membrane integrity and prevents chilling injuries in fruit. Our results show that fruit that was coated with chitosan reduced the expression of the three chilling response genes (LOX, FAD, and HSP), while fruit that was coated with both chitosan and Phe induced the expression of the chilling response genes compared to fruit that was coated with chitosan. These results suggest that chitosan with Phe application can regulate stress-responsive genes LOX, FAD and HSP and protect the fruit from cold injuries (FIG. 6).

A similar profile of expression was observed for the genes involved in the biosynthesis of phenylpropanoids; F3H, FLS, and 4CL. These genes were down-regulated in fruit that were coated with chitosan compared to the non-coated control, while these genes were up-regulated in fruit coated with both chitosan with Phe in comparison to fruit that was coated with chitosan.

Chitosan application was shown to affect fruit defense response in several studies. Recent transcriptomic analysis showed that avocado fruit coated with chitosan induced many metabolic processes in response to inoculation with Colletotrichum gloeosporioides. They also show that the avocado fruit coated with chitosan affect the expression of several genes involved in the biosynthesis of phenylpropanoids; downregulate the genes encoding CHS and FLS, whereas it up-regulates the gene encoding to 4CL. Similarly, our results show that chitosan has an effect on fruit response to cold and the phenylpropanoid pathway. Generally, these results show that the application of chitosan with Phe is able to induce several metabolic responses in avocado fruit that together implements a defense system and the phenylpropanoid pathway in response to cold. Similarly, the application of Phe to flowers was shown to elevate the flavonol level that was synthesis from the phenylpropanoid metabolic pathway. Thus, the coating with both chitosan and Phe seems to regulate the expression of avocado fruit response and phenylpropanoid related transcripts in response to sub-optimal cold temperature.

The coating compositions disclosed herein, are non-toxic and safe providing a long-lasting protection to the treated produce. All the ingredients used for the preparation of the sanitizing compositions of the invention are recognized by the FDA as Generally Recognized as Safe (the “GRAS”).

While the invention has been described using some specific examples, many modifications and variations are possible. It is therefore understood that the invention is not intended to be limited in any way, other than by the scope of the appended claims.

1. A composition, comprising an aqueous solvent and an effective amount of a polysaccharide and phenylalanine, a salt thereof or both; wherein:
the effective amount comprises a weight per weight (w/w) ratio of (i) said polysaccharide to the (ii) phenylalanine the salt thereof, or both being between 20:1 and 1:1.

2. The composition of claim 1, wherein said composition is in a form of a solution or a dispersion.

3. The composition of claim 1, wherein said effective amount comprises a concentration of (i) said polysaccharide within said composition between 0.2 to 4.0 wt %, and a concentration of the phenylalanine the salt thereof, or both within said composition between 0.02 to 0.3 wt %.

4. The composition of claim 1, wherein said polysaccharide is selected from cellulose, modified cellulose, alginate, pectin and chitosan including any salt, any combination, or any derivative thereof, optionally wherein the modified cellulose is selected from carboxymethyl cellulose (CMC), methyl cellulose (MC), hydroxypropyl methylcellulose (HPMC).

5. The composition of claim 1, further comprising additives selected from preservatives, coat efficiency assisters, pH adjusters, and viscosity adjusters; optionally wherein the additive comprises a fatty acid or a salt thereof.

6. (canceled)

7. The composition of claim 1, wherein the effective amount comprises a concentration of said polysaccharide within the composition of between 0.5 and 2.0 wt %, and a concentration of phenylalanine or a salt thereof within the composition of between 0.05 and 0.2 wt %.

8. The composition of claim 1, wherein the effective amount is sufficient for (i) prolonging the shelf-life of the edible matter by at least 10% compared to a control; (ii) reducing microbial load of the edible matter by at least 10% compared to a control, or for both (i) and (ii).

9. The composition of claim 1, comprising chitosan or a derivative thereof at a concentration of 0.2 to 4.0 wt %, and phenylalanine or a salt thereof at a concentration of 0.05 to 0.3 wt %.

10. The composition of claim 1, comprising a cellulose derivative at a concentration of 0.2 to 4.0 wt %, phenylalanine or a salt thereof at a concentration of 0.05 to 0.3 wt %, and stearic acid or a salt thereof in a concentration of 0.25 to 2.0 wt %.

11. The composition of claim 1, wherein said composition is formulated for application on the edible matter by spraying, dipping, spreading and coating, including any combination thereof.

12. The composition of claim 1, wherein said edible matter comprises a plant, a plant part or both, optionally wherein said plant part comprises a fruit, a stem, a leaf, a root, a bulb, a seed, a flower or any combination thereof.

13. (canceled)

14. (canceled)

15. A method, comprising contacting an edible matter with an effective amount of the composition of claim 1, under suitable conditions, to obtain a coated edible matter, wherein said coated edible matter is characterized by (i) prolonged shelf-life, (ii) reduced pathogen load, or both (i) and (ii).

16. The method of claim 15, wherein said method further comprising drying of the coated edible matter; and wherein said suitable conditions are sufficient for coating a surface of the edible matter.

17. (canceled)

18. The method of claim 15, wherein said suitable conditions comprise (i) contacting time of between 1 second and 1 hour; (ii) a temperature of between 5 and 70° C., or both (i) and (ii); optionally wherein said effective amount is an antimicrobial effective amount.

19. (canceled)

20. The method of claim 15, wherein said contacting is performed by a method comprising any of: spraying, submerging, dipping, and injecting or any combination thereof.

21. (canceled)

22. The method of claim 15, wherein said method is for any one of: preventing or inhibiting pathogen formation on said substrate within a time period of at least 5 days; reducing decay of said edible matter by at least 10%, as compared to a non-treated edible matter; or reducing colony forming units (CFU) on or within said edible matter by a factor of 10 to 100,000, as compared to a non-treated edible matter.

23. (canceled)

24. The method of claim 15, wherein said pathogen comprises a fungi, a mold, a bacterium, a nematode, an algae or any combination thereof, optionally wherein said pathogen comprises a plant pathogen.

25. The method of claim 15, wherein said edible matter comprises pre-harvest edible matter, or a post-harvest edible matter.

26. An edible matter coated with the composition of claim 1.

27. The edible matter of claim 26, wherein a w/w ratio between the polysaccharide and phenylalanine or a salt thereof within the composition is between 20:1 and 1:1; and wherein the edible matter is characterized by (i) prolonged shelf-life; (ii) reduced pathogen load, or both (i) and (ii), as compared to a non-treated edible matter.

28. (canceled)
